(19) United States
(12) Patent Application Publication
(10) Pub. No.: US 2024/0409062 A1
(43) Pub. Date: Dec. 12, 2024

(54) WIRELESS VEHICLE CONTROL DEVICE AND SYSTEM

(71) Applicants: INVENTEC (PUDONG) TECHNOLOGY CORPORATION, Shanghai (CN); INVENTEC CORPORATION, Taipei City (TW)

(72) Inventor: Tzu Hung WU, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/367,320

(22) Filed: Sep. 12, 2023

(30) Foreign Application Priority Data
Jun. 12, 2023 (CN) 202310691936.2

(51) Int. Cl. B60R 25/20; B60R 25/01; B60R 25/24; G07C 9/00

(52) U.S. Cl. CPC B60R 25/2018; B60R 25/01; B60R 25/24; G07C 9/00309; G07C 9/00571; B60R 2325/103; G07C 2009/00793; G07C 2209/63

(57) ABSTRACT

A wireless vehicle control device disposed in a vehicle includes two communication modules and a central management unit. The first communication module is configured to detect a first communication signal of a wearable device and includes at least one UWB communication unit. The second communication module is configured to detect a second communication signal of the wearable device, wherein a communication range of the second communication module is smaller than that of the first communication module. The central management unit is connected to the two communication modules, and is configured to pair with the wearable device according to the first communication signal. When the central management unit determines that a distance corresponding to the first communication signal is not greater than a preset distance, it activates the second communication module for detection, and controls at least one vehicle lock of the vehicle according to the second communication signal.

### CROSS-REFERENCE TO RELATED APPLICATIONS

This non-provisional application claims priority under 35 U.S.C. § 119(a) on Patent Application No(s). 202310691936.2 filed in China on Jun. 12, 2023, the entire contents of which are hereby incorporated by reference.

### BACKGROUND

### 1. Technical Field

This disclosure relates to a wireless vehicle control device and system.

### 2. Related Art

The limitations of traditional vehicle keys have been extensively examined in recent years. In addition to the need to prepare an extra set of keys to keep, you also have to face the problems of small size and easy loss of vehicle keys. If the vehicle key is stolen, you will have more concerns. Therefore, the trend of using mobile phones as vehicle keys is gradually developing. Even though the mobile phone vehicle key technology is more convenient, efficient, and time-saving than the traditional hand-held vehicle key, due to safety considerations, it may still be necessary to take out the mobile phone and then use the mobile phone password, face id to unlock etc. to provide more protection. If both hands are unavailable, or the mobile phone is placed in a bag, pocket, etc., there is an additional operation to open the door.

### SUMMARY

Accordingly, this disclosure provides a wireless vehicle control device and system.

According to one or more embodiments of this disclosure, a wireless vehicle control device which is disposed in a vehicle, includes a first communication module, a second communication module and a central management unit. The first communication module is configured to detect a first communication signal of a wearable device, and includes at least one ultra-wideband (UWB) communication unit. The second communication module is configured to detect a second communication signal of the wearable device, wherein a communication range of the second communication module is smaller than a communication range of the first communication module. The central management unit is connected to the first communication module and the second communication module, and is configured to pair with the wearable device according to the first communication signal, and when the central management unit determines that a distance corresponding to the first communication signal is not greater than a preset distance, the central management unit can activates the second communication module for detection, and controls at least one vehicle lock of the vehicle.

According to one or more embodiments of this disclosure, a wireless vehicle control system includes a wireless vehicle control device and a wearable device. The wireless vehicle control device is disposed in a vehicle, and includes a first communication module, a second communication module and a central management unit. The first communication module is configured to detect a first communication signal, and includes at least one ultra-wideband (UWB) communication unit. The second communication module is configured to detect a second communication signal, wherein a communication range of the second communication module is smaller than a communication range of the first communication module. The central management unit is connected to the first communication module and the second communication module, and is configured to pair according to the first communication signal, and when the central management unit determines that a distance corresponding to the first communication signal is not greater than a preset distance, the central management unit activates the second communication module for detection, and controls at least one vehicle lock of the vehicle. The wearable device is configured to control the at least one vehicle lock of the vehicle, and includes a third communication module and a fourth communication module. The third communication module is configured to generate the first communication signal and includes an ultra-wideband (UWB) communication unit. The fourth communication module is configured to generate the second communication signal, wherein a communication range of the fourth communication module is smaller than a communication range of the third communication module.

In view of the above description, the wireless vehicle control device and system of the present disclosure can use UWB sensor to accomplish accurate positioning, so that when the wearable device is close to the vehicle door at an appropriate distance, the communication unit with a smaller communication range is activated to unlock the vehicle door. In this way, the effect of a smart sensor door can be achieved, so that the user only needs to get the wearable device close to open the door, which solves the inconvenience of traditional vehicle keys and mobile phone smart vehicle keys.

The above description of the present disclosure and the following description of the implementation are used to demonstrate and explain the spirit and principle of the present disclosure, and provide a further explanation of the claims of the present disclosure.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a wireless vehicle control device according to an embodiment of the present disclosure.

FIG. 2 is a flow chart of operation of a wireless vehicle control device according to an embodiment of the present disclosure.

FIG. 3 is a flow chart of operation of a wireless vehicle control device according to another embodiment of the present disclosure.

FIG. 4 is a schematic diagram illustrating a vehicle, a wireless vehicle control device and a wearable device.

FIG. 5 is a block diagram of a wireless vehicle control system according to another embodiment of the present disclosure.

FIG. 6 is a block diagram of a wireless vehicle control device according to one or more embodiments of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

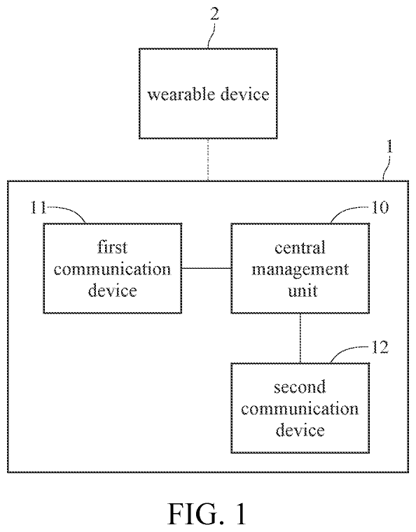

Please refer to FIG. 1 which is a block diagram of a wireless vehicle control device according to an embodiment of the present disclosure. As shown in FIG. 1, a wireless vehicle control device 1 includes a central management unit 10, a first communication module 11 and a second communication module 12. The first communication module 11 is configured to detect a first communication signal of a wearable device 2, and includes at least one ultra-wideband (UWB) communication unit. The second communication module 12 is configured to detect a second communication signal of the wearable device 2, wherein a communication range of the second communication module 12 is smaller than a communication range of the first communication module 11. The central management unit 10 is connected to the first communication module 11 and the second communication module 12, and is configured to pair with the wearable device 2 according to the first communication signal, and when the central management unit 10 determines that a distance corresponding to the first communication signal is not greater than a preset distance, the central management unit 10 activates the second communication module 12 for detection, and controls at least one vehicle lock of the vehicle.

The wearable device 2 may include smart devices such as smart watches and smart bracelets that can be worn by users. Compared with smart phone, the wearable device 2 is more convenient to use, and can reduce the operation steps required by the user to control the locking/unlocking of the vehicle lock, as detailed in the following description. In the present embodiment, the wireless vehicle control device 1 is disposed in a vehicle and connected to at least one vehicle lock (not shown) of the vehicle. In particular, the wireless vehicle control device 1 can be installed in the vehicle close to the vehicle door and connected to the corresponding vehicle lock of the vehicle door, but the present application is not limited thereto.

The central management unit 10 of the wireless vehicle control device 1 may include one or more computing units such as a central processing unit (CPU), a graphics processing unit (GPU), a programmable logic controller or a microcontroller, etc., to execute various processes of the wireless vehicle control device 1. The first communication module 11 includes at least one UWB communication unit. Specifically, the first communication module 11 may include a plurality of UWB communication units, wherein each UWB communication unit includes an UWB signal transceiver for receiving and transmitting UWB signals. The second communication module 12 may include a second communication unit of which the communication range is smaller than that of the UWB communication unit. For example, the second communication unit can be a near-field communication (NFC) unit. It should be noted that the central management unit 10 can be disposed on a motherboard along with the first communication module 11 and the second communication module 12, and the central management unit 10 is connected to the first communication module 11 and the second communication module 12 through connection wires. Or, the central management unit 10 can be disposed on a motherboard separated from the first communication module 11 and the second communication module 12, and the central management unit 10 can be connected to the first communication module 11 and the second communication module 12 in a wireless way.

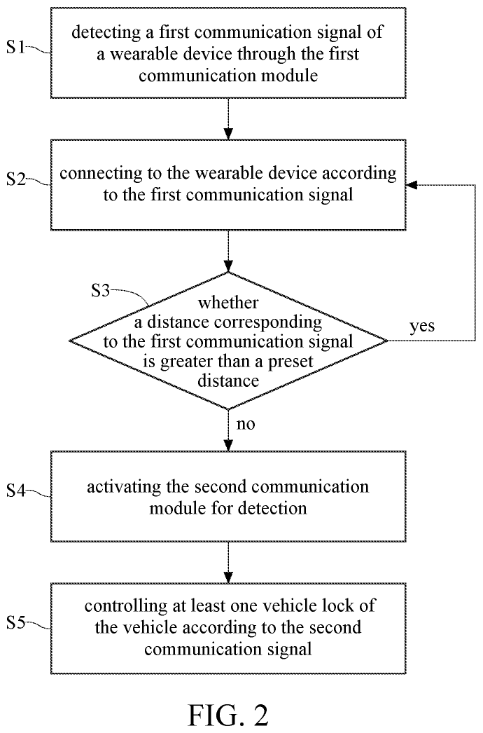

Please refer to FIG. 2 along with FIG. 1, FIG. 2 is a flow chart of operation of a wireless vehicle control device according to an embodiment of the present disclosure. As shown in FIG. 2, the central management unit of the wireless vehicle control device can perform: step S1: detecting a first communication signal of a wearable device through the first communication module; step S2: connecting to the wearable device according to the first communication signal; step S3: determining whether a distance corresponding to the first communication signal is greater than a preset distance; if the determination result in step S3 is “yes”, back to performing step S2, if the determination result in step S3 is “no”, performing step S4: activating the second communication module for detection; and step S5: controlling at least one vehicle lock of the vehicle according to the second communication signal.

In step S1, the first communication module 11 can constantly detect surrounding areas within a range, and transmit the first communication signal detected to the central management unit 10. In the present embodiment, the communication range of the UWB communication unit of the first communication module 11 is about 10 meters, that is, when the user carrying the wearable device 2 approaches the first communication module 11 and reaches to be within the communication range mentioned above, the central management unit 10 can receive the first communication signal transmitted by the wearable device 2. In step S2, the central management unit 10 can connect with the wearable device 2 according to the first communication signal detected. Specifically, before step S1, the wearable device 2 may perform a pairing operation with the wireless vehicle control device 1 in advance. The pairing operation includes: the wireless vehicle controller 1 detects the first communication signal transmitted by the wearable device 2, and stores identification information of the first communication signal. In this way, in step S2, the central management unit 10 can identify the identification information of the first communication signal, and connect with the wearable device 2.

In step S3, the central management unit 10 can calculate the distance between the first communication module 11 and the wearable device 2 according to the first communication signal through time-of-flight (ToF), and determine whether the distance is greater than a preset distance, wherein the preset distance can be associated with the communication range of the second communication module 12. Specifically, when the central management unit 10 calculates and determines that the distance is greater than the preset distance, it can determine that the distance between the wearable device 2 and the second communication module 12 exceeds the communication range of the second communication module 12. Therefore, the second communication module 12 is not activated for detection, in the meantime the connection between the first communication module 11 and the wearable device 2 is maintained.

In step S4, when the central management unit 10 calculates the distance between the first communication module 11 and the wearable device 2 according to the first communication signal through time-of-flight (ToF), and determines that the distance is not greater than the preset distance, the central management unit 10 can determine that the distance between the wearable device 2 and the second communication module 12 is within the communication range of the second communication module 12, so it can activate the second communication module 12 for detection. In step S5, the central management unit 10 can control at least one vehicle lock of the vehicle when the second communication signal transmitted by the wearable device 2 is detected by the second communication module 12. For example, the user can select the operation related to the vehicle lock through the user interface of the wearable device 2, so that the second communication signal can carry specific operation information (on/off and the specific position of the vehicle lock). The central management unit 10 then performs control operations on the vehicle lock according to the second communication signal.

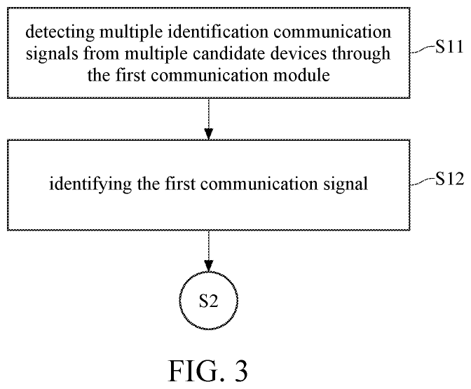

Please refer to FIG. 3 along with FIG. 2, FIG. 3 is a flow chart of operation of a wireless vehicle control device according to another embodiment of the present disclosure. As shown in FIG. 3, when there are multiple candidate devices around the wireless vehicle control device, the central management unit of the wireless vehicle control device can, before step S2, perform: step S11: detecting multiple identification communication signals from multiple candidate devices through the first communication module; and step S12: identifying the first communication signal. Specifically, the central management unit can pre-store the identification information of the paired wearable device, and then, according to the identification information, identify the first communication signal of the wearable device from a plurality of communication signals to be identified respectively from a plurality of candidate devices, so as to perform connection in step S2.

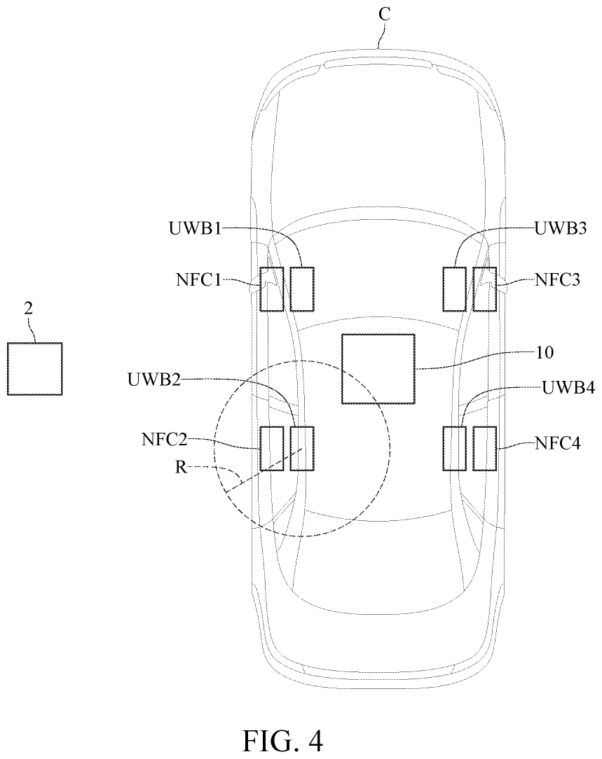

Please refer to FIG. 4 which is a schematic diagram illustrating a vehicle, a wireless vehicle control device and a wearable device. As shown in FIG. 4, a central management unit 10 is disposed in the vehicle C, and an ultra-wideband communication unit and a near-field communication unit are disposed at a position corresponding to each door (and the corresponding door lock), that is, for example, the left front door corresponds to a first ultra-wideband communication unit UWB1 and a first near-field communication unit NFC1, the left rear door corresponds to a second ultra-wideband communication unit UWB2 and a second near-field communication unit NFC2, the right front door corresponds to a third ultra-wideband communication unit UWB3 and a third near-field communication unit NFC3, and the right rear door corresponds to a fourth ultra-wideband communication unit UWB4 and a fourth near-field communication unit NFC4. Each NFC unit has its own communication range. For example, the communication range of the second near-field communication unit NFC2 can cover the area surrounding the left rear door. The wearable device 2 is configured to transmit the first communication signal and the second communication signal to open a specific car door.

As shown in FIG. 4, the communication range R of the NFC unit is about 10 cm, and the wearable device 2 is not within the communication range of the NFC unit. When the wearable device 2 approaches any UWB communication unit at a distance within 10 meters, the central management unit 10 can perform pairing connection with the wearable device 2 through the UWB communication unit. Further, the central management unit 10 can be configured to calculate position information according to multiple distances of the first communication signal relative to the multiple UWB communication units, and decide whether to activate the second communication module for detection according to the position information. The above calculation of position information can be realized by triangulation method, which is not described in detail herein.

When the distance between the wearable device 2 and the vehicle keeps decreasing, the central management unit 10 can continuously update the distance or position information, maintain the connection between the wearable device 2 and the UWB communication unit, and decide whether to activate the NFC unit for detection. Specifically, when the distance between the wearable device 2 and a specific car door is within a specific range, the central management unit 10 can obtain the position information through the above-mentioned method, and activate a corresponding one of the NFC units according to the position information for detection. For example, when the second near field communication unit NFC2 detects the second communication signal from the wearable device 2, the central management unit 10 can control the vehicle lock of the left rear door of the vehicle C according to the second communication signal. It should be noted that the UWB communication unit and the NFC unit shown in the present embodiment are disposed adjacent to each other, so that the distance measured through the first communication signal can correspondingly represent the distance between the wearable device 2 and the NFC unit. However, in other embodiments, the UWB communication unit and the NFC unit can be disposed in different positions, and the central management unit 10 can perform additional calculations on the distance obtained according to the first communication signal to determine whether the wearable device 2 is close to the near field communication unit.

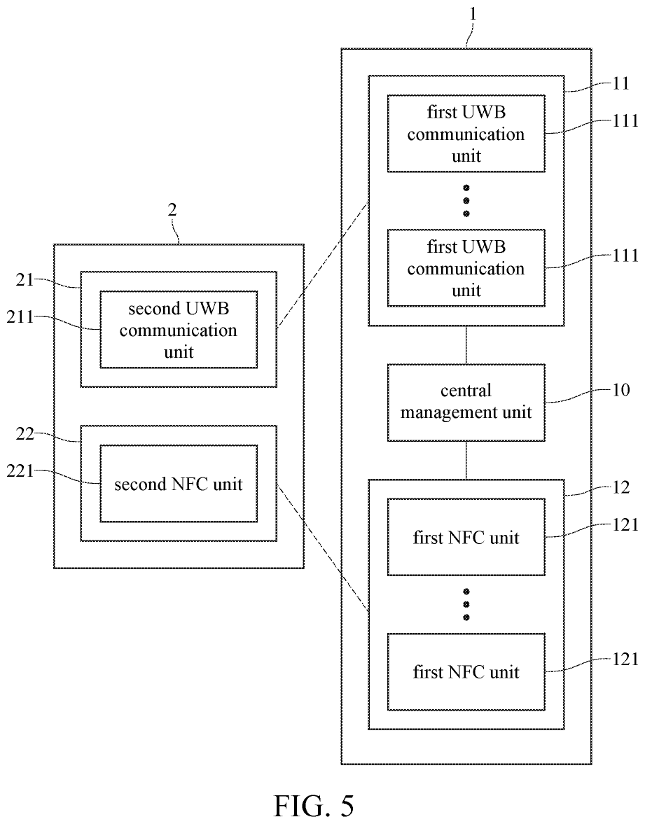

Please refer to FIG. 5, which is a block diagram of a wireless vehicle control system according to another embodiment of the present disclosure. As shown in FIG. 5, the wireless vehicle control system includes a wireless vehicle control device 1 and a wearable device 2. The wearable device 2 is configured to control at least one vehicle lock of a vehicle, and includes a third communication module 21 and a fourth communication module 22. The third communication module 21 is configured to generate a first communication signal and includes an ultra-wideband (UWB) communication unit. The fourth communication module 22 is configured to generate a second communication signal, wherein a communication range of the fourth communication module 22 is smaller than a communication range of the third communication module 21. The wireless vehicle control device 1 is disposed in the vehicle, and includes a central management unit 10, a first communication module 11 and a second communication module 12. The first communication module 11 is configured to detect a first communication signal of the wearable device 2, and includes at least one ultra-wideband (UWB) communication unit. The second communication module 12 is configured to detect a second communication signal of the wearable device 2, wherein a communication range of the second communication module 12 is smaller than a communication range of the first communication module 11. The central management unit 10 is connected to the first communication module 11 and the second communication module 12, and is configured to pair with the wearable device 2 according to the first communication signal, and when the central management unit 10 determines that a distance corresponding to the first communication signal is not greater than a preset distance, the central management unit 10 activates the second communication module 12 for detection, and controls at least one vehicle lock of the vehicle.

In the present embodiment, the second communication module 12 of the wireless vehicle control device 1 may include at least one first near-field communication unit 121. and other related operations are the same as those of the previous embodiments. The second UWB communication unit 211 of the wearable device 2 can continuously transmit the first communication signal for detection by the first UWB communication unit 111. The second NFC unit 221 of the wearable device 2 can continuously send out the second communication signal for the first NFC unit 121 to detect. In addition, the wearable device 2 can also have a processing unit similar to the central management unit 10, such as a central processing unit, a graphics processing unit, a programmable logic controller or a microcontroller, etc., to be controlled by the user's operation whether to transmit the first communication signal and the second communication signal.

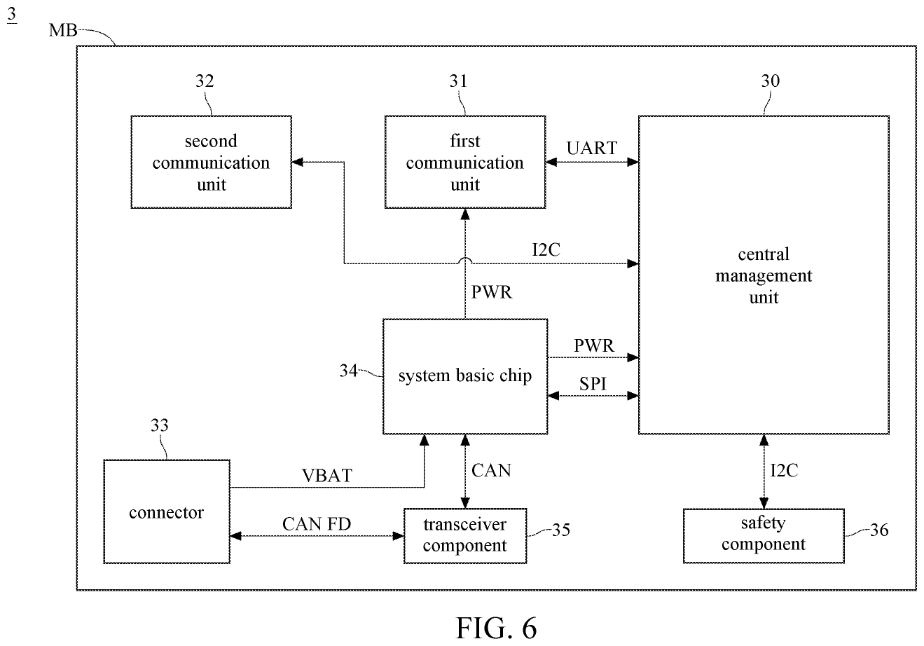

Please refer to FIG. 6 which is a block diagram of a wireless vehicle control device according to one or more embodiments of the present disclosure. As shown in FIG. 6, the wireless vehicle controller 3 includes a central management unit 30, a first communication unit 31, a second communication unit 32, a connector 33, a system basic chip 34, a transceiver component 35 and a security component 36. The central management unit 30, the first communication unit 31, the second communication unit 32, the connector 33, the system basic chip 34, the transceiver unit 35 and the security component 36 can be connected and disposed on a motherboard MB. The motherboard MB may be a control board provided between the driver's seat and the passenger's seat.

The central management unit 30, the first communication unit 31 and the second communication unit 32 of the wireless vehicle controller 3 can be the same as the central management unit 10, the first communication module 11 and the second communication module 12 of the embodiment shown in FIG. 1 which is not repeated herein. The first communication unit 31 is connected to the central management unit 30 through a universal asynchronous receiver/transmitter (UART). The second communication unit 32 is connected to the central management unit 30 through an inter-integrated circuit (I2C). The system basic chip 34 can be a power management IC (PMIC). The system basic chip 34 is configured to supply power to the wireless vehicle controller 3 and perform power management. The system basic chip 34 can receive a voltage battery (VBAT) from the connector 33, connect to the central management unit 30 through the serial peripheral interface (SPI), and supply power (PWR) to the central management unit 30. The transceiver element 35 is connected to the connector 33 through controller area network of a flexible data rate (CAN FD), and is connected to the system basic chip 34 through a controller area network (CAN bus). The transceiver component 35 can be a local interconnect network (LIN) transceiver. The safety component 36 is connected to the central management unit 30 through an inter-integrated circuit (I2C), and is configured to execute encryption and decryption algorithms for communication signals, such as asymmetric algorithms.

In one or more embodiments of the present disclosure, the wireless vehicle control device and system of the present invention can be applied to vehicle devices, such as autonomous cars, electric cars, or semi-autonomous cars, etc.

In view of the above description, the wireless vehicle control device and system of the present disclosure can use UWB sensor to accomplish accurate positioning, so that when the wearable device is close to the vehicle door at an appropriate distance, the communication unit with a smaller communication range is activated to unlock the vehicle door. In this way, the effect of a smart sensor door of step-by-step identification can be achieved, so that the user only needs to get the wearable device close to open the door, which solves the inconvenience of traditional vehicle keys and mobile phone smart vehicle keys.

Although the present invention is disclosed by the aforementioned embodiments, they are not intended to limit the present invention. Without departing from the spirit and scope of the present invention, all changes and modifications are within the scope of claims of the patent. For the scope of protection defined by the present invention, please refer to the appended scope of patent application.

What is claimed is:

1. A wireless vehicle control device, disposed in a vehicle, and comprising:
a first communication module configured to detect a first communication signal of a wearable device, and comprising at least one ultra-wideband communication unit;
a second communication module configured to detect a second communication signal of the wearable device, wherein a communication range of the second communication module is smaller than a communication range of the first communication module; and
a central management unit connected to the first communication module and the second communication module, and configured to connect with the wearable device according to the first communication signal, and when the central management unit determines that a distance corresponding to the first communication signal is not greater than a preset distance, the central management unit activates the second communication module for detection and controls at least one vehicle lock of the vehicle.

2. The wireless vehicle control device of claim 1, wherein the central management unit is configured to pre-store identification information corresponding to the wearable device, and identify the first communication signal of the wearable device from a plurality of communication signals to be identified respectively from a plurality of candidate devices, for connection.

3. The wireless vehicle control device of claim 1, wherein the second communication module comprises at least one near-field communication unit.

4. The wireless vehicle control device of claim 1, wherein the at least one ultra-wideband communication unit is a plurality of ultra-wideband communication units, and the central management unit is further configured to calculate position information according to a plurality of distances of the first communication signal relative to the plurality of ultra-wideband communication units, and activate the second communication module for detection according to the position information.

5. The wireless vehicle control device of claim 1, wherein the second communication module comprises a plurality of near-field communication units, and the at least one vehicle lock is a plurality of vehicle locks, wherein the plurality of near-field communication units respectively corresponds to the plurality of vehicle locks, and the central management unit is further configured to calculate position information according to a distance of the first communication signal relative to the first communication module, and activate a corresponding one of the plurality of near-field communication units for detection according to the position information.

6. A wireless vehicle control system, comprising:
a wireless vehicle control device disposed in a vehicle, comprising:
a first communication module configured to detect a first communication signal, and comprising at least one ultra-wideband communication unit;
a second communication module configured to detect a second communication signal, wherein a communication range of the second communication module is smaller than a communication range of the first communication module; and
a central management unit connected to the first communication module and the second communication module, and configured to connect according to the first communication signal, and when the central management unit determines that a distance corresponding to the first communication signal is not greater than a preset distance, the central management unit activates the second communication module for detection and controls at least one vehicle lock of the vehicle, and
a wearable device configured to control the at least one vehicle lock of the vehicle, and comprising:
a third communication module configured to generate the first communication signal, and comprising an ultra-wideband communication unit; and
a fourth communication module configured to generate the second communication signal, wherein a communication range of the fourth communication module is smaller than a communication range of the third communication module.

7. The wireless vehicle control system of claim 6, wherein the central management unit is configured to pre-store identification information corresponding to the wearable device, and identify the first communication signal of the wearable device from a plurality of communication signals to be identified respectively from a plurality of candidate devices, for connection.

8. The wireless vehicle control system of claim 6, wherein the fourth communication module comprises a near-field communication unit, and the second communication module comprises at least one near-field communication unit.

9. The wireless vehicle control system of claim 6, wherein the at least one ultra-wideband communication unit of the first communication module is a plurality of ultra-wideband communication units, and the central management unit is further configured to calculate position information according to a plurality of distances of the first communication signal relative to the plurality of ultra-wideband communication units of the first communication module, and activate the second communication module for detection according to the position information.

10. The wireless vehicle control system of claim 6, wherein the second communication module comprises a plurality of near-field communication units and the at least one vehicle lock is a plurality of vehicle locks, wherein the plurality of near-field communication units of the second communication module respectively corresponds to the plurality of vehicle locks, and the central management unit is further configured to calculate position information according to a distance of the first communication signal relative to the first communication module, and activate a corresponding one of the plurality of near-field communication units of the second communication module for detection according to the position information.
